(19) United States
(12) Patent Application Publication
(10) Pub. No.: US 2011/0123782 A1
(43) Pub. Date: May 26, 2011

(54) RECYCLABLE COATED BANNER SUBSTRATE

(75) Inventors: ERIC W. TEATHER, Elkton, MD (US); Seqwana T. Pryor, (US); Richard T. Chou, (US)

(73) Assignee: E.I. DU PONT DE NEMOURS AND COMPANY, Wilmington, DE (US)

(21) Appl. No.: 12/624,684

(22) Filed: Nov. 24, 2009

(51) Int. Cl. B32B 27/08; B32B 27/02; B32B 3/10

(52) U.S. Cl. 428/195.1; 428/520; 428/516; 442/170

(57) ABSTRACT

Disclosed is a recyclable coated banner substrate comprising (1) a composition comprising (a) copolymers of ethylene and maleic anhydride or its functional equivalents and (b) ethylene copolymers with polar comonomers such as ethylene/vinyl acetate copolymers, ethylene/alkyl (meth)acrylate copolymers and ethylene/(meth)acrylate/carbon monoxide terpolymers, and (2) a planar polyolefin banner substrate wherein the composition is affixed to at least one side of the planar polyolefin banner substrate.

### FIELD OF THE INVENTION

The present invention relates to banners comprising materials suitable for recycling.

### BACKGROUND OF THE INVENTION

Banner substrates suitable for printing can be made from various materials such as nonwovens, wovens, knits and films which are in turn made from different polymers including polyolefins, polyesters and polyamides. Sometimes to improve printability on the banner substrate, a coating is added. One common coating is polyvinylchloride. Also, additional coatings can be applied to provide improve processing or aesthetic properties.

It is desirable to make coated banner substrates that are recyclable so that they do not add to the solid waste problem. Unfortunately, polyvinylchloride is difficult to recycle because of its chemical dissimilarity to typical banner substrates.

What is needed is a coated banner substrate that is suitable for recycling wherein the coating and the banner substrate are chemically compatible. This type of banner could be recycled via a simple process of grinding the banner into chips and feeding the chips to a melt extruder to prepare polymer pellets for further melt processing into new products.

### SUMMARY OF THE INVENTION

A recyclable coated banner substrate comprising (1) a composition comprising (a) a copolymer obtained from copolymerization of ethylene and maleic anhydride or its functional equivalent, wherein maleic anhydride or its functional equivalent is present in the copolymer in an amount of from 3 to 15 weight %, in an amount from about 5 to about 95 weight % of the composition, and (b) at least one ethylene copolymer obtained from copolymerization of ethylene with a polar monomer wherein said polar comonomer is present in the copolymer in an amount of from 6 to 40 weight %, wherein said copolymer is selected from the group consisting of ethylene/vinyl acetate copolymers, ethylene/alkyl (meth)acrylate copolymers and ethylene/(meth)-acrylate/carbon monoxide terpolymers, in an amount from about 5 to about 95 weight % of the composition, and (2) a planar polyolefin banner substrate comprising two sides wherein the composition is affixed to at least one side of the planar polyolefin banner substrate.

### DETAILED DESCRIPTION OF THE INVENTION

Recyclable coated banner substrates can be made comprising (1) a composition comprising (a) copolymers of ethylene and maleic anhydride or its functional equivalents and (b) ethylene copolymers with polar comonomers such as ethylene/vinyl acetate copolymers, ethylene/alkyl (meth)acrylate copolymers and ethylene/(meth)acrylate/carbon monoxide terpolymers, and (2) a planar polyolefin banner substrate wherein the composition is affixed to at least one side of the planar polyolefin banner substrate.

Compositions suitable for the present invention are disclosed in U.S. patent application publication number 2006/0160952, herein incorporated by reference. These compositions comprise (a) a copolymer obtained from copolymerization of ethylene and maleic anhydride or its functional equivalent, wherein maleic anhydride or its functional equivalent is present in the copolymer in an amount of from 3 to 15 weight %, in an amount from about 5 to about 95 weight % of the composition, and (b) at least one ethylene copolymer obtained from copolymerization of ethylene with a polar monomer wherein said polar comonomer is present in the copolymer in an amount of from 6 to 40 weight %, wherein said copolymer is selected from the group consisting of ethylene/vinyl acetate copolymers, ethylene/alkyl (meth)acrylate copolymers and ethylene/(meth)-acrylate/carbon monoxide terpolymers, in an amount from about 5 to about 95 weight % of the composition. Additional additives can be added to provide color, improve opacity and improve UV stability.

Planar polyolefin banner substrate suitable for the present invention have two sides. The substrate comprises polyolefins of polyethylene and polypropylene. The substrate is selected from the group consisting of nonwovens, wovens, knits and films. The nonwovens comprise fibers made by a melt spun, spun bond or flash spun process.

The coated banner substrate is prepared by affixing the composition to at least one side of the planar polyolefin banner substrate. For example, the composition can be extrusion coated onto the substrate. Also, the composition can be applied to the substrate by powder scattering, powder dot application or paste dot application.

The coated banner substrate can be any color, typically white.

The coated banner substrate may be printed thereon using ink to create the desired message, design or image.

### EXAMPLE

Hereinafter the present invention will be described in more detail in the following example.

A recyclable coated banner substrate was produced by extrusion coating Tyvek® 1085D (flash spun high density polyethylene available from DuPont) having a basis weight of 108 gm² with a coating composition of 95% by weight of Entiracoat™ 100 (ethylene acid copolymer available from DuPont) and 5% by weight of Ampacet White UV PE MB 816341 (additive for improving opacity from Ampacet) providing a basis weight of approximately 100 gm² on each side.

Since the Tyvek® and the Entiracoat™ 100 are chemically similar, they can easily be recycled via melt extrusion.

What is claimed is:

1. A recyclable coated banner substrate comprising:
(1) a composition comprising:
(a) a copolymer obtained from copolymerization of ethylene and maleic anhydride or its functional equivalent, wherein maleic anhydride or its functional equivalent is present in the copolymer in an amount of from 3 to 15 weight %, in an amount from about 5 to about 95 weight % of the composition; and
(b) at least one ethylene copolymer obtained from copolymerization of ethylene with a polar monomer wherein said polar comonomer is present in the copolymer in an amount of from 6 to 40 weight %, wherein said copolymer is selected from the group consisting of ethylene/vinyl acetate copolymers, ethylene/alkyl (meth)acrylate copolymers and ethylene/(meth)-acrylate/carbon monoxide terpolymers, in an amount from about 5 to about 95 weight % of the composition; and
(2) a planar polyolefin banner substrate comprising two sides wherein the composition is affixed to at least one side of the planar polyolefin banner substrate.

2. The recyclable coated banner substrate of claim 1 wherein the copolymer of (a) is obtained from copolymerization of ethylene and maleic anhydride.

3. The recyclable coated banner substrate of claim 1 wherein the copolymer of (a) is obtained from copolymerization of ethylene and a functional equivalent of maleic anhydride selected from maleic acid and/or salts thereof, maleic acid diesters, maleic acid monoesters, itaconic acid, fumaric acid, fumaric acid monoester, and mixtures of any of these.

4. The recyclable coated banner substrate of claim 3 wherein the maleic diesters or monoesters are esters of C1 to C4 alcohols.

5. The recyclable coated banner substrate of claim 4 wherein the copolymer of (a) is obtained from copolymerization of ethylene and a maleic acid monoester.

6. The recyclable coated banner substrate of claim 5 wherein the maleic acid monoester is ethyl hydrogen maleate.

7. The recyclable coated banner substrate of claim 2 wherein component (b) is an ethylene/vinyl acetate copolymer.

8. The recyclable coated banner substrate of claim 2 wherein component (b) is an ethylene/alkyl (meth)acrylate copolymer.

9. The recyclable coated banner substrate of claim 1 wherein the planar polyolefin banner substrate comprises polyolefins of polyethylene and polypropylene.

10. The recyclable coated banner substrate of claim 1 wherein the planar polyolefin banner substrate is selected from the group consisting of nonwovens, wovens, knits and films.

11. The recyclable coated banner substrate of claim 10 wherein the nonwovens comprise fibers made by a melt spun, spun bond or flash spun process.

12. The recyclable coated banner substrate of claim 1 prepared by extrusion coating the composition comprising (a) and (b) onto the planar polyolefin banner substrate.

13. The recyclable coated banner substrate of claim 1 prepared by applying a composition comprising (a) and (b) onto the planar polyolefin banner substrate by powder scattering, powder dot application or paste dot application.

14. A printed banner comprising the coated banner substrate of claim 1 printed thereupon.
